(19) United States
(12) Patent Application Publication
(10) Pub. No.: US 2013/0138358 A1
(43) Pub. Date: May 30, 2013

(54) ALGORITHMS FOR SEQUENCE DETERMINATION

(71) Applicants: Susan Tang, Los Altos, CA (US); Jon Sorenson, Alameda, CA (US)

(72) Inventors: Susan Tang, Los Altos, CA (US); Jon Sorenson, Alameda, CA (US)

(73) Assignee: Pacific Biosciences of California, Inc., Menlo Park, CA (US)

(21) Appl. No.: 13/468,347

(22) Filed: May 10, 2012

Related U.S. Application Data
(63) Continuation-in-part of application No. 13/034,233, filed on Feb. 24, 2011.
(60) Provisional application No. 61/307,732, filed on Feb. 24, 2010.

(51) Int. Cl. G06F 19/22

(52) U.S. Cl. CPC G06F 19/22
USPC 702/20

(57) ABSTRACT

The present invention is generally directed to powerful and flexible methods and systems for consensus sequence determination from replicate biomolecule sequence data. It is an object of the present invention to improve the accuracy of consensus biomolecule sequence determination from replicate sequence data by providing methods for assimilating replicate sequence into a final consensus sequence more accurately than any one-pass sequence analysis system.

### CROSS-REFERENCE TO RELATED APPLICATIONS

This application is a continuation-in-part of U.S. patent application Ser. No. 13/034,233, filed Feb. 24, 2011, which claims the benefit of Provisional U.S. Patent Application No. 61/307,732, filed Feb. 24, 2010, both of which are incorporated herein by reference in their entireties for all purposes.

### STATEMENT REGARDING FEDERALLY SPONSORED RESEARCH

Not Applicable.

### BACKGROUND OF THE INVENTION

Advances in biomolecule sequence determination, in particular with respect to nucleic acid and protein samples, has revolutionized the fields of cellular and molecular biology. Facilitated by the development of automated sequencing systems, it is now possible to sequence whole genomes. However, the quality of the sequence information must be carefully monitored, and may be compromised by many factors related to the biomolecule itself or the sequencing system used, including the composition of the biomolecule (e.g., base composition of a nucleic acid molecule), experimental and systematic noise, variations in observed signal strength, and differences in reaction efficiencies. As such, processes must be implemented to analyze and improve the quality of the data from such sequencing technologies.

One strategy for improving sequence data is to use redundant sequence data, e.g., as a means to improve accuracy by allowing random errors to be identified and resolved in the final sequence determination. However, the methods currently used are typically restrictive with regards to the types of polymorphisms that may be analyzed and the types of error models that can be used. As such, there is a need for a more powerful and flexible method for consensus sequence determination from redundant biomolecule sequence data.

Various embodiments and components of the present invention employ signal and data analysis techniques that are familiar in a number of technical fields. For clarity of description, details of known analysis techniques are not provided herein. These techniques are discussed in a number of available reference works, such as: R. B. Ash. Real Analysis and Probability. Academic Press, New York, 1972; D. T. Bertsekas and J. N. Tsitsiklis. Introduction to Probability. 2002; K. L. Chung. Markov Chains with Stationary Transition Probabilities, 1967; W. B. Davenport and W. L Root. An Introduction to the Theory of Random Signals and Noise. McGraw-Hill, New York, 1958; S. M. Kay, Fundamentals of Statistical Processing, Vols. 1-2, (Hardcover—1998); Monsoon H. Hayes, Statistical Digital Signal Processing and Modeling, 1996; Introduction to Statistical Signal Processing by R. M. Gray and L. D. Davisson; Modern Spectral Estimation: Theory and Application/Book and Disk (Prentice-Hall Signal Processing Series) by Steven M. Kay (Hardcover—January 1988); Modern Spectral Estimation: Theory and Application by Steven M. Kay (Paperback—March 1999); Spectral Analysis and Filter Theory in Applied Geophysics by Burkhard Buttkus (Hardcover—May 11, 2000); Spectral Analysis for Physical Applications by Donald B. Percival and Andrew T. Walden (Paperback—Jun. 25, 1993); Astronomical Image and Data Analysis (Astronomy and Astrophysics Library) by J. L. Starck and F. Murtagh (Hardcover—Sep. 25, 2006); Spectral Techniques In Proteomics by Daniel S. Sem (Hardcover—Mar. 30, 2007); Exploration and Analysis of DNA Microarray and Protein Array Data (Wiley Series in Probability and Statistics) by Dhammika Amaratunga and Javier Cabrera (Hardcover—Oct. 21, 2003).

### BRIEF SUMMARY OF THE INVENTION

The invention is generally directed to processes for analyzing replicate sequence information, and for ultimately identifying a consensus sequence of a biomolecular target sequence from the replicate sequence information. Consequently, the invention is also directed to systems that carry out these processes.

The invention and various specific aspects and embodiments will be better understood with reference to the following detailed descriptions and figures, in which the invention is described in terms of various specific aspects and embodiments. These are provided for purposes of clarity and should not be taken to limit the invention. The invention and aspects thereof may have applications to a variety of types of methods, devices, and systems not specifically disclosed herein.

Furthermore, the functional aspects of the invention that are implemented on a computer or other logic processing systems or circuits, as will be understood to one of ordinary skill in the art, may be implemented or accomplished using any appropriate implementation environment or programming language, such as C, C++, Cobol, Pascal, Java, Java-script, HTML, XML, dHTML, assembly or machine code programming, RTL, etc.

The present invention is generally directed to powerful and flexible methods and systems for consensus sequence determination from replicate biomolecule sequence data. Technologies and methods for biomolecule sequence determination do not always produce sequence data that is perfect. For example, it is often the case that DNA sequencing data does not unambiguously identify every base with 100% accuracy, and this is particularly true when the sequencing data is generated from a single pass, or “read.” Using replicate sequence information provides a means to improve validation of sequence reads as compared to single sequence fragment analysis alone. As such, it is an object of the present invention to improve the accuracy of consensus biomolecule sequence determination from replicate sequence data. In certain aspects, the current invention provides algorithms for assimilating replicate sequence into a final consensus sequence more accurately than any one-pass sequence analysis system.

In certain aspects, the methods are computer-implemented methods. In certain aspects, the algorithm and/or results (e.g., consensus sequences generated) are stored on computer-readable medium, and/or displayed on a screen or on a paper print-out. In certain aspects, the results are further analyzed, e.g., to identify genetic variants, to identify a source of the replicate sequence information, to identify genomic regions conserved between individuals or species, to determine relatedness between two individuals, to provide an individual with a diagnosis or prognosis, or to provide a health care professional with information useful for determining an appropriate therapeutic strategy for a patient.

Methods for refining multiple sequence alignments are provided. In certain embodiments, such methods comprise providing an initial multiple sequence alignment; perturbing a portion of the initial multiple sequence alignment to generate a candidate multiple sequence alignment having a perturbed portion; evaluating the candidate multiple sequence alignment by scoring the portion of the initial multiple sequence alignment to generate a first score, and scoring the perturbed portion of the candidate multiple sequence alignment to generate a second score; and accepting the candidate multiple sequence alignment as a new multiple sequence alignment if the second score is greater than the first score. The initial multiple sequence alignment typically comprises a biomolecular sequence, e.g., a polynucleotide sequence. In certain embodiments, the method further comprises performing at least one sequencing reaction to provide the biomolecular sequence, e.g., a sequencing-by-incorporation assay. Preferably, the providing comprises aligning a plurality of replicate sequence reads using one or more MSA algorithms. Typically, the method is iteratively applied, wherein the new multiple sequence alignment is subsequently perturbed and evaluated. The perturbing can comprise performing a gap shifting operation on at least one column of the initial multiple sequence alignment. The scoring can comprise computation of a geometric mean of a signal-to-noise ratio within the column and/or application of an objective function, e.g.,

$$S = \sqrt[\vert block \vert]{{\prod }_{i = 1}^{i = \vert block \vert} \frac{Count ( most\_frequent \_base \_in {\_col}_{i} )}{Count ( 2 nd\_frequent \_base \_in {\_col}_{i} )}} .$$

In certain aspects, methods are provided for determining a consensus call. In certain embodiments, such methods comprise generating a set of training sequence reads from a known template sequence using a given sequencing system; using the set of training sequence reads and a given alignment schema to generate a training multiple sequence alignment, where a read is a series of units, and wherein a unit is either a base call or a single base gap; measuring unit association occurrences in the training multiple sequence alignment; determining conditional probabilities for each combination of training sequence units and a known template sequence unit; generating a set of experimental sequence reads from an unknown template sequence using the given sequencing system; using the set of experimental sequence reads and the given alignment schema to generate an experimental multiple sequence alignment; for each column in the experimental multiple sequence alignment having a plurality of units therein, using the conditional probabilities to compute the likelihoods of observing the plurality of units for each of a set of possible template units for the column; and identifying which of the possible template units gives the highest likelihood in step g and identifying it as the consensus call for the column. In some preferred embodiments, the methods further comprise using a χ2 statistic to determine confidence in the consensus call for the column.

In certain aspects, methods for generating a consensus sequence for a region of a multiple sequence alignment are provided. Such methods preferably comprise providing a multiple sequence alignment comprising a set of actual reads across a region of interest; providing a set of randomly generated candidate reads for the region of interest having a length equal to a mean length of the actual reads; measuring an edit distance between each of the randomly generated candidate reads and the set of actual reads to generate a fitness for each of the randomly generated candidate reads; selecting a subset of the randomly generated candidate reads, wherein the selecting preferentially chooses randomly generated candidate reads having high fitness with respect to others in the set of randomly generated candidate reads; pairing members of the subset selected in the selecting step to produce a plurality of pairs of candidate reads; subjecting each of the pairs of candidate reads to a crossover procedure to generate a first set of recombined candidate reads; subjecting the set of recombined candidate reads to the measuring, selecting, pairing, and subjecting steps to generate a further set of recombined reads, and sequentially repeating this step, each time using the set of recombined candidate reads from an immediately prior crossover procedure for a subsequent measure of the edit distance; terminating the sequentially repeating, thereby providing a final set of recombined candidate reads; measuring an edit distance between each member of the final set of recombined candidate reads and the set of actual reads to generate a fitness for each member of the final set of recombined candidate reads; and determining which member of the final set of recombined candidate reads has a best fitness as a fittest candidate read, and identifying the fittest candidate read as the consensus sequence for the region of the multiple sequence alignment. In certain preferred embodiments, fitness is computed using an equation, e.g.,

$$Fitness ( x ) {e}^{- ( \frac{{\sum }_{{S}_{i}} ∈ READ \_ {SET}^{EditDist} ( {S}_{i} , X )}{\vert READ \_ SET \vert} )} .$$

Preferably, the “selecting a subset of the randomly generated candidate reads” step preferably retains some of the randomly generated candidate reads having low fitness with respect to others in the set of randomly generated candidate reads, and optionally can be performed using a roulette-wheel selection. In some embodiments, multiple fittest candidate reads are identified in the determining step, and the method further comprises constructing an undirected and weighted graph comprising nodes representing a first of the multiple fittest candidate read and portions of the actual reads that overlap the first within the multiple sequence alignment; repeating the constructing step for all of the fittest candidate reads; generating a minimum spanning tree for each of the undirected and weighted graphs constructed, thereby generating a set of minimum spanning trees; determining which of the minimum spanning trees has a highest degree edge, wherein the highest degree edge is an edge that participates in the greatest number of template-to-read paths; and identifying which of the multiple fittest candidate reads is represented within the minimum spanning tree having the highest degree edge, wherein this multiple fittest candidate read is chosen as the consensus sequence for the region of the multiple sequence alignment. Each of the fittest candidate reads can be a root of one of the set of minimum spanning trees. Further, the edit distance can be computed using a combination of base calls from the actual reads and base quality values for each of the base calls.

In certain aspects, systems for generating a consensus sequence are provided. Such systems typically comprise computer memory containing an alignment of a set of replicate sequence reads; computer-readable code for determining an optimal Steiner string for the alignment, wherein the optimal Steiner string is the consensus sequence; and memory for storing the consensus sequence so generated.

### BRIEF DESCRIPTION OF THE DRAWINGS

FIG. 1 is a flow diagram providing a general embodiment of the invention.

FIG. 2 provides an example of multiple sequence reads that may be used with the methods and systems of the invention.

FIG. 3 provides an illustrative example of a multiple sequence alignment.

FIG. 4 illustrates a preferred embodiment of a simulated annealing framework used to search and evaluate a solution space.

FIG. 5 provides an illustrative example of a gap-shifting operation for an MSA having three sequence reads, S1, S2, and S3.

FIG. 6 illustrates a preferred general approach for identifying and determining consensus sequences for posts and islands.

FIG. 7 provides an illustrative example of a consensus approximation approach that utilizes the Steiner string framework.

FIG. 8 provides a graphical representation of a given set of reads for a template AGA.

FIG. 9 provides a comparison of minimum spanning trees for two different templates fitted to the set of reads in FIG. 8.

FIG. 10 is a block diagram showing a representative example of a configuration of a device for consensus sequence determination in which various aspects of the invention may be embodied.

FIG. 11 provides results from an assessment of an MSA refinement procedure, further described in the Examples.

FIG. 12 provides results from a comparison of consensus calling accuracy using the quality value-based algorithm provided herein versus a plurality-based strategy.

### DETAILED DESCRIPTION OF THE INVENTION

### I. GENERAL

Sequencing applications generally fall into two categories, de novo assembly and re-sequencing. Both efforts require highly-automated, accurate assembly of nucleic acid fragments into contigs. They differ in that de novo assembly is performed using overlapping reads, while re-sequencing assumes knowledge of a reference sequence and maps reads to the reference. Although establishing relative read position is significantly easier for re-sequencing, the subsequent task of calling a consensus base for each aligned column in the contig or alignment is still challenging. The standard of sequencing accuracy was set to 99.99% by the National Human Genome Research Institute (NHGRI) in 1998. While a single base call for each position in a template may not achieve such accuracy, but with increases in coverage multiple overlapping sequencing reads for a template sequence having lower raw read accuracy can be used to determine a consensus sequence with acceptably high accuracy. Consensus calling algorithms attempt to distinguish sequencing error from variants (e.g., SNPs) using multiple “queries” for a given position. A variety of such algorithms have been developed to address changes in sequencing coverage, error profiles, and information accompanying base calls as new sequencing systems are developed, e.g, Li, et al. (2008) Genome Res. 18:1851-1858; and Chen, et al. (2007) Genome Res. 17(5):659-666. Other methods and algorithms that may be used with or are otherwise related to the methods provided herein are found in G. A. Churchill, M. S. Waterman (1992) “The Accuracy of DNA Sequences: Estimating Sequence Quality,” Genomics 14: 89-98; M. Stephens, et al. (2006) “Automating sequence-based detection and genotyping of SNPs from diploid samples,” Nat. Genet., 38: 375-381; Li, et al (2008) “Mapping short DNA sequencing reads and calling variants using mapping quality scores,” Genome Research 18(11):1851-8; and Chen, et al. (2007) “PolyScan: An automatic indel and SNP detection approach to the analysis of human resequencing data,” Genome Research 17(5):659-666, the disclosures of which are incorporated herein by reference in their entireties for all purposes. Further methods and algorithms that may be used with or are otherwise related to the methods provided herein are found in U.S. Patent Publication Nos. 20090024331 and 20100169026, and U.S. patent application Ser. Nos. 13/034,233 and 13/034,199, both filed Feb. 24, 2011, all of which are incorporated by reference herein in their entireties for all purposes.

The present invention is generally directed to powerful and flexible methods and systems for consensus sequence determination from replicate biomolecule sequence data. Technologies and methods for biomolecule sequence determination do not always produce sequence data that is perfect. For example, it is often the case that DNA sequencing data does not unambiguously identify every base with 100% accuracy, and this is particularly true when the sequencing data is generated from a single pass, or “read.” Using replicate sequence information provides a means to improve validation of sequence reads as compared to single sequence fragment analysis alone. As such, it is an object of the present invention to improve the accuracy of consensus biomolecule sequence determination from replicate sequence data. In certain aspects, the current invention provides algorithms and processes for assimilating replicate sequence into a final consensus sequence more accurately than any one-pass sequence analysis system. For example, using the methods described herein a consensus sequence having 99.9% accuracy can be generated from twelve sequencing reads generated by sequencing a single template nucleic acid, where each of the sequencing reads has a single-pass accuracy of about 86%. These twelve sequencing reads can be used in the methods herein to generate a highly accurate consensus sequence for the single template nucleic acid. In preferred embodiments, the consensus sequencing accuracy achieved using the methods herein is at least 95%, 96%, 97%, 98%, 99%, 99.5%, 99.9%, or 99.99%.

In certain aspects, the methods provided herein comprise identifying regions of a biomolecule for which sequencing data are ambiguous. In certain embodiments, a plurality of regions in a biomolecule for which sequencing data are ambiguous are identified as Islands of Ambiguity (IAs), or just “islands.” These regions are adjacent to and/or between other regions of the biomolecule identified as Columns of Certainty (CCs), sometimes referred to as “posts.” In certain aspects, a threshold value is used to evaluate the sequence data to determine if a position is within a CC (post) or an IA (island). In further aspects, ambiguous data for positions identified as within an island are resolved to generate a consensus sequence for that region. In preferred embodiments, a probabilistic graph model is used to determine the consensus sequence for at least one or more islands. In particular embodiments, the methods involve determination of a plurality of consensus sequences for a plurality of islands identified by analysis of replicate sequencing reads of a biomolecule, e.g., a DNA molecule. Consensus sequences for each island in a biomolecule may optionally be combined with sequence data for posts in the biomolecule to generate a template consensus sequence extending across a combination of at least one island and at least one post, e.g., across multiple islands and the intervening posts, e.g., across a target sequence in the template.

In certain preferred embodiments, the problem of calling a consensus sequence from a plurality of sequence reads is formulated as a maximization problem using a Bayesian approach and a generalized representation of the information imparted by each individual read. Further, certain preferred sequencing technologies generate sequencing reads that possess information beyond the individual called bases. For example, single-molecule, real-time sequencing-by-synthesis technologies can provide sequence reads that comprise not only base call information, but also various aspects of the kinetic characteristics of the reaction, which can be used to derive various metrics including, e.g., the likelihood of various error modalities and alternate sequence interpretations. This additional information, in combination with the called bases, is used to better refine the consensus sequence determination. Benefits of this approach include a faster climb to consensus accuracy with increasing coverage, and reduced sensitivity to underlying systematic error.

Sequences from various kinds of biomolecules may be analyzed by the methods presented herein, e.g., polynucleotides and polypeptides. The biomolecule may be naturally-occurring or synthetic, and may comprise chemically and/or naturally modified units, e.g., acetylated amino acids, methylated nucleotides, etc. Methods for detecting such modified units are provided, e.g., in U.S. Ser. No. 12/635,618, filed Dec. 10, 2009; and Ser. No. 12/945,767, filed Nov. 12, 2010, which are incorporated herein by reference in their entireties for all purposes. In certain embodiments, the biomolecule is a nucleic acid, such as DNA, RNA, cDNA, or derivatives thereof. In some preferred embodiments, the biomolecule is a genomic DNA molecule. The biomolecule may be derived from any living or once living organism, including but not limited to prokaryote, eukaryote, plant, animal, and virus, as well as synthetic and/or recombinant biomolecules.

For ease of discussion, various aspects of the invention will be described with regards to analysis of polynucleotide sequences, but it is understood that the methods and systems provided herein are not limited to use with polynucleotide sequence data and may be used to determine consensus sequences for other types of sequence data, e.g., from polypeptide sequencing reactions.

### II. REPLICATE SEQUENCE READS

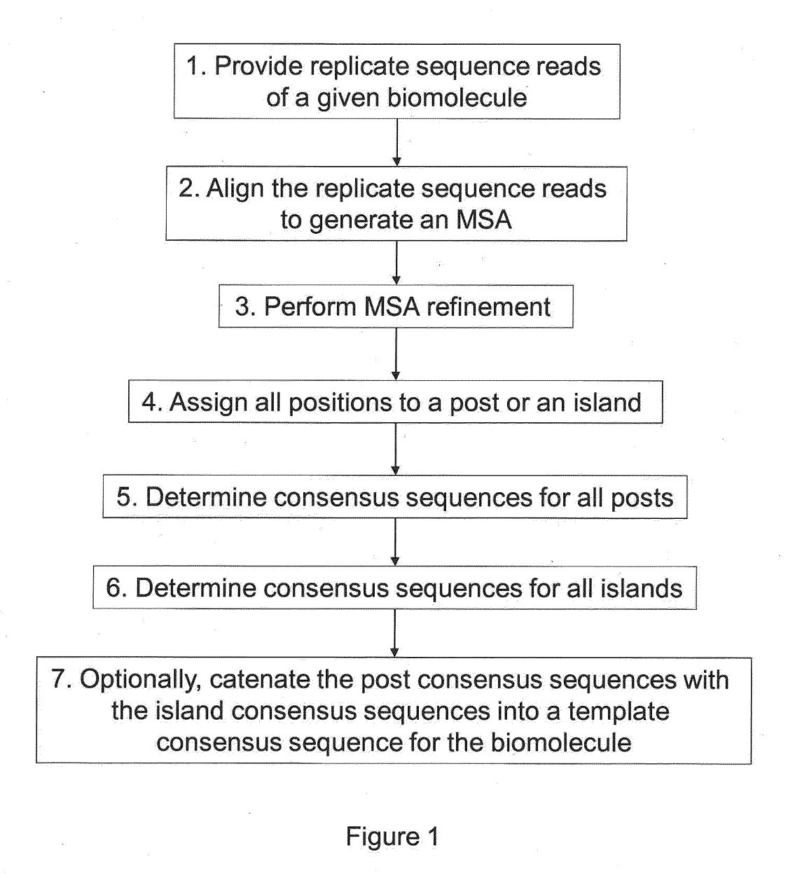

FIG. 1 provides an overview of an exemplary analysis schema for consensus sequence analysis. At step 1, replicate sequence reads are provided for a given biomolecule. Essentially any technology capable of generating sequence data from biomolecules may be used to generate the replicate sequence reads, e.g., Maxam-Gilbert sequencing, chain-termination methods, PCR-based methods, hybridization-based methods, ligase-based methods, microscopy-based techniques, sequencing-by-synthesis (e.g., pyrosequencing, SMRT® sequencing, SOLiD™ sequencing (Life Technologies), semiconductor sequencing (Ion Torrent Systems), tSMS™ sequencing (Helicos BioSciences), Illumina® sequencing (Illumina, Inc.), nanopore-based methods (e.g., BASE™), etc.). In certain preferred embodiments, the technology used comprises a zero-mode waveguide (ZMW). The fabrication and application of ZMWs in biochemical analyses, and methods for calling bases in sequencing applications performed within ZMWs, e.g., sequencing-by-incorporation methods, are described, e.g., in U.S. Pat. Nos. 6,917,726, 7,013,054, 7,056,661, 7,170,050, 7,181,122, and 7,292,742, U.S. Patent Publication No. 20090024331, and U.S. Ser. No. 13/034,199 (filed Feb. 24, 2011), as well as in Eid, et al. (Science 323:133-138 (2009)) and Korlach, et al. (Methods Enzymol 472:431-455 (2010)) the full disclosures of which are incorporated herein by reference in their entirety for all purposes.

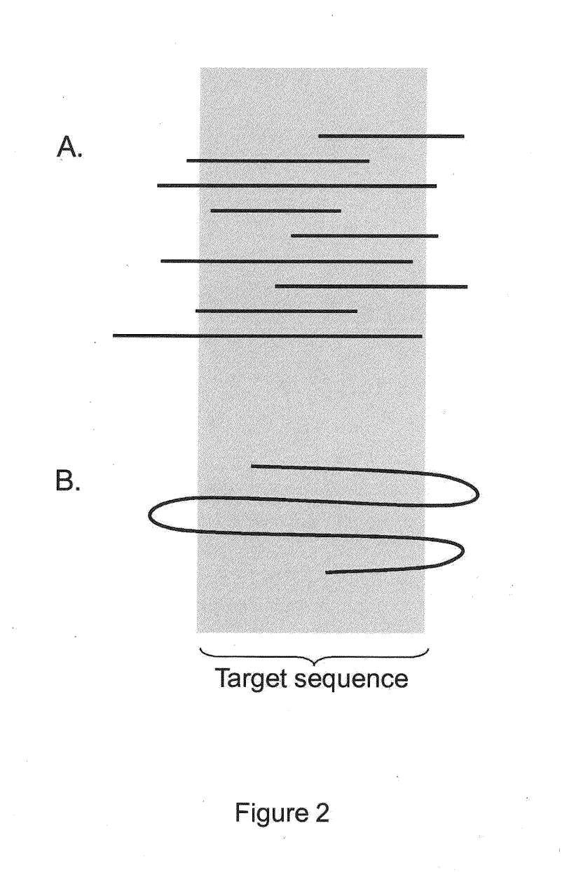

The multiple sequence reads may be generated in any number of ways, including, e.g., repeatedly sequencing the same molecule, sequencing a template comprising multiple copies of the target sequence, sequencing multiple individual biomolecules all of which contain the sequence of interest or “target” sequence, or a combination of such approaches. The replicate sequence reads need not begin and end at the same position in the biomolecule sequence, as long as they contain at least a portion of the target sequence, and in some preferred embodiments contain at least a portion of an island. FIG. 2 provides exemplary replicate sequences. In FIG. 2A, the replicate sequences are from separate sequence reads, e.g., as produced by parallel sequencing strategies. In FIG. 2B, the replicate sequences are contained within a single sequencing read, such as when a circular template is repeatedly sequenced, or when a template contains multiple copies of the target sequence. For example, in certain sequence-by-synthesis applications, such a circular template can be used to generate replicate sequence reads of the target sequence by allowing a polymerase to synthesize a linear concatemer by continuously generating a nascent strand from multiple passes around the template molecule. Examples of methods of generating replicate sequence information from a single molecule are provided, e.g., in U.S. Pat. No. 7,476,503; U.S. Patent Publication No. 20090298075; U.S. Patent Publication No. 20100075309; U.S. Patent Publication No. 20100075327; U.S. Patent Publication No. 20100081143, U.S. Ser. No. 61/094,837, filed Sep. 5, 2008; and U.S. Ser. No. 61/099,696, filed Sep. 24, 2008, all of which are assigned to the assignee of the instant application and incorporated herein by reference in their entireties for all purposes. Further, each read may also comprise information in addition to sequence data (e.g., basecalls), such as estimations of per-position accuracy, features of underlying sequencing technology output (e.g., trace characteristics (integrated counts per peak, shape/height/width of peaks, distance to neighboring peaks, characteristics of neighboring peaks), signal-to-noise ratios, power-to-noise ratio, background metrics, signal strength, reaction kinetics, etc.), and the like.

In certain embodiments, one aspect of the set of replicate sequence reads is that they have been determined to belong together by a previous stage of processing. In other words, there is an assumption that the set of reads contains replicate sequence data that must be validated. In certain embodiments in which the reads are coming from separate single molecules (e.g., as shown in FIG. 2A), a grouping may be necessary to ensure each read in the set contains sequence information for the target sequence of interest. For example, the reads in the set may be identified as covering at least a portion of the same target sequence by a mapping method, e.g., de novo assembly or alignment to a reference sequence. Such a grouping is not necessary for cases in which the nature of the source of the sequence reads has validated the assumption that the reads belong together, such as cases in which the replicate sequences were generated by sequential sequencing of the same or identical target sequences in a single template molecule to produce a single read or multiple reads containing replicate sequences (e.g., as shown in FIG. 2).

### III. MULTIPLE SEQUENCE ALIGNMENT

At step 2 of FIG. 1, the replicate sequence reads are aligned to correlate each call in each read to a given position in the target sequence, thereby generating a “multiple sequence alignment” (MSA). In a general sense, an MSA is a representation of a common alignment of several (e.g., more than two) overlapping sequences, which provides more information than a single pairwise alignment. For example, a single polypeptide sequence can be matched against an entire polypeptide sequence family, or a single nucleotide sequence can be matched against a set of homologous sequences from different chromosomes and/or individuals in a population. The MSA is useful in various aspects, including aiding in the discovery of evolutionary relationships between different individuals (e.g., organisms, species, strains, etc.), and identification of key regions of such sequences (e.g., highly conserved regions are usually key functional regions and potentially prime targets for drug development; polypeptide sequence motifs can be predictive of secondary, tertiary, and possibly even quaternary structure.) MSAs can also provide the basis for consensus sequence calling given a set of sequencing reads from the same template or identical copies thereof. The methods herein may operate with numerous methods for sequence alignment including those generated by various types of known MSA algorithms. For example, the sequence alignment may comprise one or more MSA algorithm-derived alignments that align each read using a reference sequence. For example, in some embodiments in which a reference sequence is known for the region containing the target sequence, the reference sequence can be used to produce an MSA using a variant of the center-star algorithm or using a phylogenetic tree alignment. For example, a sequence alignment can be obtained by comparing each read to the reference sequence using a pairwise local alignment algorithm (e.g., Smith-Waterman, YASS, MUMMER, LALIGN, etc.), and combining the pairwise alignments using a standard MSA algorithm. In some embodiments, a scoring matrix is employed (e.g., BLOSUM or PAM). Optionally, one can combine all the pairwise alignments in such a way as to preserve the location of all gaps in the original reads. Often, dynamic programming algorithms are used to determine a best alignment for a given MSA. Alternatively or in addition, the sequence alignment may comprise one or more MSA algorithm-derived alignments that align each read relative to every other read without using a reference sequence (“de novo assembly routines”), e.g., PHRAP, CAP, ClustalW, T-Coffee, AMOS make-consensus, center star method, or other dynamic programming MSAs. Depending on the sequence-generating methods used, the determination of sequence alignment may also involve analysis of read quality (e.g., using TraceTuner™, Phred, etc.), signal intensity, peak data (e.g., height, width, shape, proximity to neighboring peak(s), etc.), information indicative of the orientation of the read (e.g., 5′→3′ designations), clear range identifiers indicative of the usable range of calls in the sequence, and the like. Such read quality may be used to exclude certain low quality reads from the alignment process.

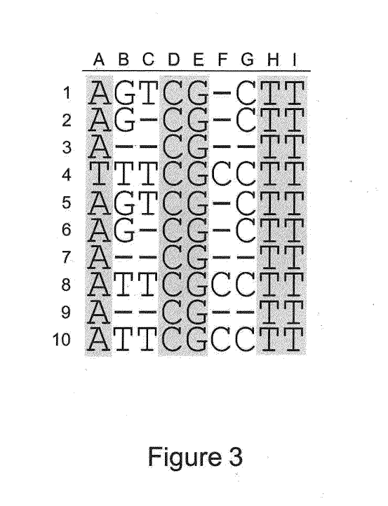

FIG. 3 illustrates an exemplary polynucleotide multiple sequence alignment (MSA) with ten reads (rows 1-10) and nine nucleotide positions (columns A-I). As such, each “row” in the MSA represents a set of base calls corresponding to a single polynucleotide sequence read, and each “column” in the MSA contains a set of base calls that are aligned to represent a single position in the target nucleic acid sequence from which the reads were generated. Preferably, the base calls within a row are base calls for adjacent positions or loci within the sequence read. For example, in nucleotide sequence data, a column can be the set of basecalls for a nucleotide position overlapped by a plurality of assembled sequencing reads, where each read provides one of the basecalls for the column. As noted above, such overlapping sequence reads can be generated in various ways, including but not limited to resequencing a target sequence within a single nucleic acid template, sequencing multiple different templates that all comprise the target sequence, sequencing a template nucleic acid that contains multiple copies of the target sequence, or combinations of such approaches. A nucleotide base call is shown at each position for each read except those positions indicated with a dash “—,” which indicates that no call is provided for that position in that read. For example, the call may be indiscernible or of too low a quality to be included in the alignment, or the read may have shown no nucleotide at that position in the template sequence (e.g., possibly due to a deletion). In some embodiments, one or more dashes are added during the alignment process to allow bases in different reads that are located at the same position in a template sequence to align with one another in an MSA for subsequent analyses.

Time and memory requirements for MSA determination increase exponentially with the number of sequences to be represented in the MSA. Therefore, avoiding an exhaustive search of possible alignment configurations and applying some sort of heuristic or random search to find the optimal solution is widely practiced. To produce highly accurate MSAs efficiently, after an existing, approximate solution is established, a series of rearrangements is made to optimize the solution according to some objective function to improve the resulting alignments. However, prior methods demonstrating success tended to evaluate the biological relevance of the alignments by referring to structural alignments. For example, the BALiBASE benchmark dataset contains manually constructed MSAs that result from 3D structural superpositions. The methods described herein provide new methods and objective functions for high quality alignments of sequence data.

In certain aspects, the present invention provides an MSA refinement procedure using Simulated Annealing and a different objective function than others known in the art (e.g., Sum of Pairs and COFFEE). MSA refinement is shown as step 3 of FIG. 1. Certain applications of simulated annealing are described in the art, e.g., in Kirkpatrick, et al. (1983) Science, New Series 220(4598):671-80; and Keith, et al. (2002) Bioinformatics 18(11):1494-1499, both of which are incorporated herein by reference in their entireties for all purposes. The use of this objective function (OF) not only produces better MSAs, e.g., from nucleotide sequence data, but also has a fairly low computational complexity and is easily implemented. Methods for MSA refinement known in the art may be used in conjunction with the instant invention. For example, see Notredame, et al. (1996) Nuc. Ac. Res. 24:1515-24; Wang, et at. (2005) BMC Bioinformatics 6:200; and Kim, et al. (1994) Comput. Applic Biosci. 10:419-26, all of which are incorporated herein by reference in their entireties for all purposes.

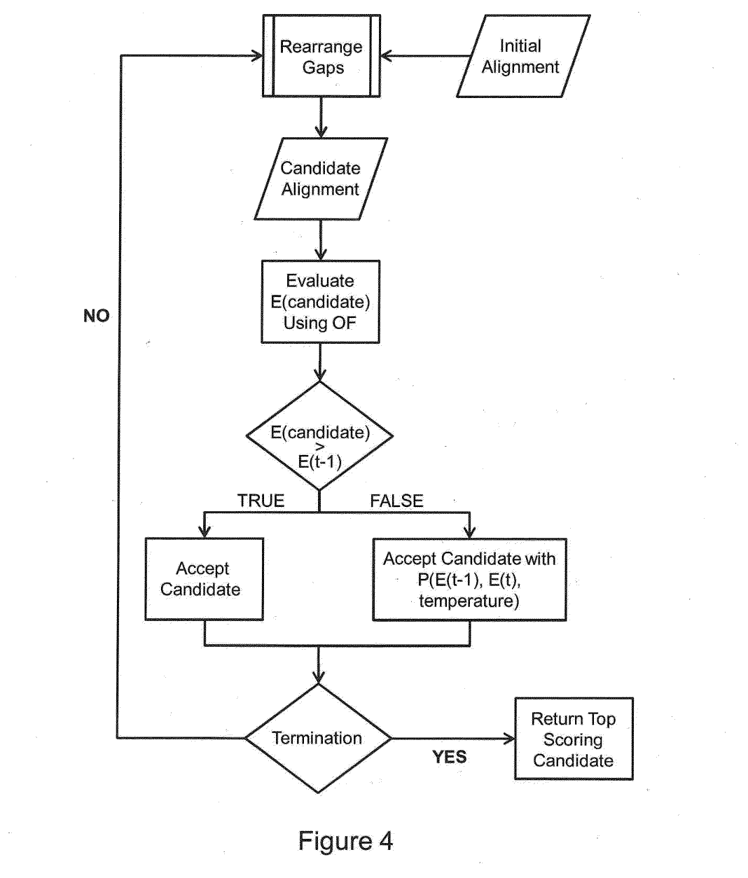

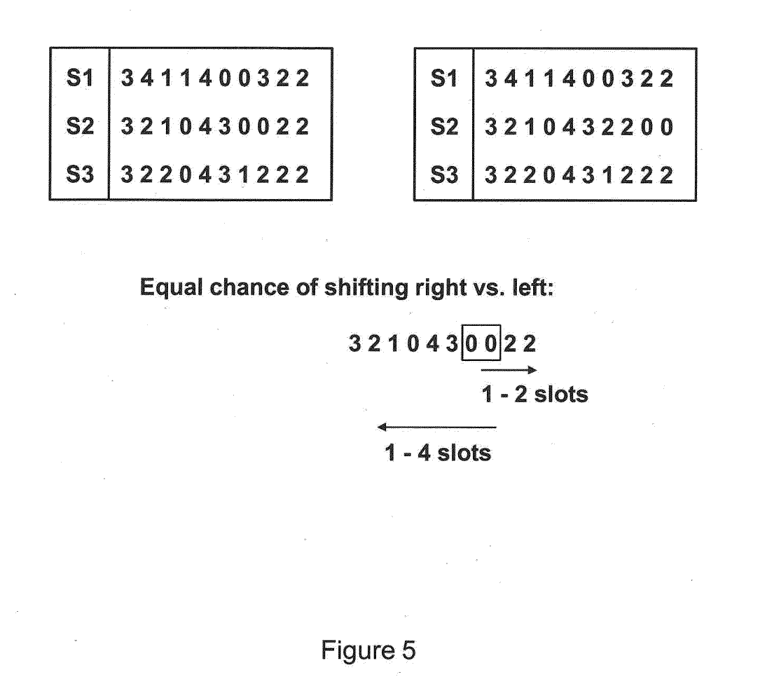

A preferred embodiment of a simulated annealing framework used to search and evaluate the solution space is shown in FIG. 4. The initial alignment (step 2 in FIG. 1) is a close approximation of the optimal solution, which is subsequently subjected to local refinement (step 3 in FIG. 1). The initial alignment can be generated by a “quick and dirty” assembly based on a pair-wise alignment algorithm (e.g., Center Star method, and others known in the art). New candidate alignments are generated by making a local perturbation of the current alignment. For example, an alignment can be disrupted by selecting, e.g., randomly or selectively, one or more columns in the MSA and performing a gap shifting operation with some probability for each sequence having a gap in those columns. FIG. 5 provides an illustrative example of a gap-shifting operation for an MSA having three sequence reads, S1, S2, and S3. Gap shifts can occur to the right or to the left of the current column. The simulated annealing framework requires an objective function to evaluate the “goodness” of a candidate alignment at any point in the process. In this method, each new candidate is evaluated using the “GeoRatio” objective function described herein, which scores an alignment block as follows:

$$S = \sqrt[\vert block \vert]{{\prod }_{i = 1}^{i = \vert block \vert} \frac{Count ( most\_frequent \_base \_in {\_col}_{i} )}{Count ( 2 nd\_frequent \_base \_in {\_col}_{i} )}}$$

“Alignment blocks” refer to nonoverlapping regions comprising multiple adjacent positions or “columns” within an MSA. Although an alignment block may contain islands or posts or portions thereof, they are not defined based on the location of islands and posts within the MSA. This scoring mechanism effectively computes the geometric mean of the signal-to-noise ratio within a column, where a column is a set of “calls” for a given position in the assembled reads as explained above. It is beneficial to use the geometric mean as opposed to some other measure such as the arithmetic mean because the desired measure is the percentage of change across two alignments (e.g., one having and one lacking the gap shift), not the absolute magnitude of change. To illustrate this point: an increase of quantity x in the score of a low quality column does not have the same impact on downstream consensus calling as the same increase in the score of a high quality column. It is higher priority to improve low quality columns since those are likely to be miscalled at the consensus level.

The new candidate alignment is accepted with a probability of 1 if its score is better than the current solution and is accepted with some probability if the score is worse than the current solution. Bad trades are occasionally made in order to prevent the algorithm from sinking into a local optimum. The temperature (an evolving parameter in the simulated annealing algorithm) used at each iteration of the process can be set using an exponential decay function such that it lowers progressively with the number of iterations, and the chance with which you would accept a bad solution decreases as the temperature cools. After making the decision to accept or reject the candidate, the process either stops (if termination criteria are met) or proceeds to the next iteration. In certain preferred embodiments, termination criteria are met when n iterations have passed without improvement or after exceeding a predefined number of iterations. In general, n is determined empirically by the user based on the particular application. In certain preferred embodiments, n is at least about 20. This MSA refinement improves low coverage consensus calling.

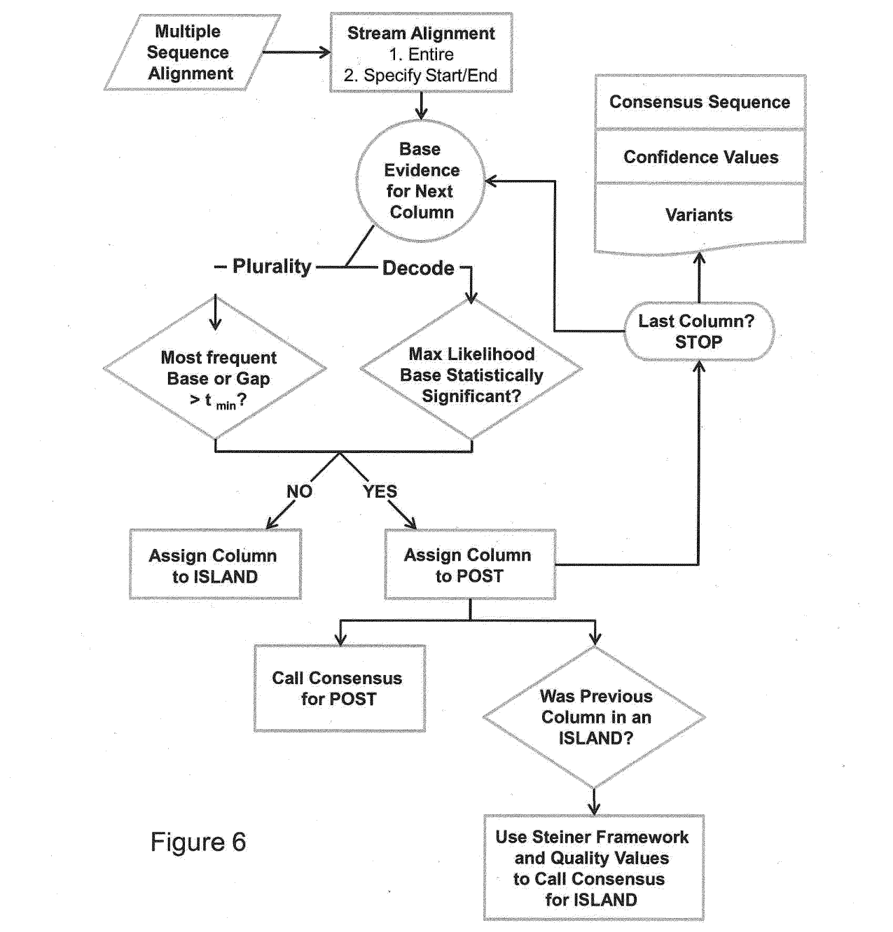

The above MSA determination and MSA refinement methods provide alternatives for the input to consensus determination, as further described below. The consensus determination method includes identification of posts and islands within the MSA, as in step 4 of FIG. 1. A preferred general approach is illustrated in the flow diagram provided in FIG. 6. This approach comprises use of a multiple sequence alignment, e.g., constructed using a center-star MSA algorithm or the alignment determination and/or refinement methods described above, from which columns containing base calls and base quality values are streamed. For post identification, either the Plurality or the Decode method can be employed. The Plurality method takes the most frequent base and checks to see if it exceeds a user-specified threshold. Decode is a max likelihood method described below. Both these methods will either identify a column as a post (and call the best (consensus) base) or will add the column to a growing island region (steps 4 and 5 of FIG. 1). Each island is analyzed (e.g., its consensus sequence is determined) once its flanking posts are determined. Island consensus sequence determination is described in greater detail below. The output for this workflow comprises variants in GFF3 format, and confidence values and consensus sequence compressed into HDF5 format.

The Decode method measures the combined effect of systematic sequencing error and alignment schema, and utilizes this information to determine the most likely base (or lack of one) on the template given an aligned column of base calls. In certain preferred embodiments, the method uses a reference-based multiple sequence alignment to examine the causal association of reference and read on a per-column basis, and condenses the information generated to expose post-alignment error tendencies that are non-random. The measured probabilities are applicable to other MSAs provided that the sequencing reads therein are affected by the same systematic sequencing error and the MSA was generated using the same alignment schema. For example, the reads in additional MSAs to be analyzed should preferably originate from the same sequencing system, and the alignment strategy to generate the MSA should use the same parameters, as were those used in the reference-based sequence alignment. Therefore, the learning or “training” aspect of the methodology using the reference sequence as described above is performed sparingly, possibly only once, and need not be repeated for every MSA to be analyzed. As such, the actual consensus sequence determination post-training can be run very quickly at run-time. In addition, the algorithm is column-independent, and therefore supports parallelization work for scalability to higher-order (e.g., larger) genomes.

In a first phase of the method, an alignment schema of interest for sequencing applications is chosen and used to generate a reference-based alignment of training reads. In one such embodiment, the alignment schema is used to denote all relevant parameters necessary to carry out a Smith-Waterman alignment between a pair of query/target sequences, where the target is a reference sequence. Various alignment tools are known and available to the ordinary practitioner, e.g., Smith-Waterman, YASS, MUMMER, LALIGN, etc. The parameters can include, but are not limited to, gap opening penalty, gap extension penalty, and DNA weight matrix. Using this alignment, the unit association occurrences between the reference and observation for each aligned column are measured. The term “unit” refers to each of the four deoxyribonucleotides (e.g., A, G, C, T) as well as gaps (-). For example, the unit association occurrence for the column ACAAT-AA, where the first letter “A” comes from the reference sequence, can be summarized into a table as shown below. The table as shown is incomplete until all columns in an alignment are analyzed and recorded. Once complete, the table will provide the sum of each type of observed unit (base calls and gaps) for each type of reference unit.

| | Observed Units | | | | | |
|---|---|---|---|---|---|---|
| Reference | | A | C | G | T | — |
| Units | A | 4 | 1 | 0 | 1 | 1 |
| | C | 0 | 0 | 0 | 0 | 0 |
| | G | 0 | 0 | 0 | 0 | 0 |
| | T | 0 | 0 | 0 | 0 | 0 |
| | — | 0 | 0 | 0 | 0 | 0 |

From this occurrence table, association counts, denoted 0(unit_{observed}, unit_{reference}), can be tabulated into a more meaningful statistic, namely conditional probabilities. For example, the probability of observing an “A” in the sequencing read given the corresponding position in the reference is a “C”:

A total of 25 conditional probabilities P(unit_{observed}|unit_{reference}) are computed, where unit_{observed}={A, C, G, T, -} and unit_{reference}={A, C, G, T, -}. Once the conditional probabilities are derived from the reference-based alignment of the training reads, these frequencies can be used to generate consensus sequence base calls for alignments of “real” sequencing reads, e.g., de novo sequencing reads.

As noted above, in order for the above described conditional probabilities or “trained frequencies” to be used to analyze actual sequencing data, the actual sequencing reads must have sequencing bias characteristics (error modes, systemic error, etc.) consistent with the training data, and the same alignment schema needs to be used for both the training and actual data. For analysis of the actual sequencing reads in an MSA, one column is processed at a time. In a given column, the likelihood of observing the data d₁, d₂, d₃, . . . dₙ given the template t is computed by:

P(d1, d2, d3, dn|t)=Πₖ₌₁ⁿP(unit_{observed}=dₖ|unit_{reference}=t)

The likelihood is computed under each possible assumption of the template unit, namely {A, C, G, T, -}, and the assumption that maximizes P(d₁, d₂, d₃, . . . dₙ|t), denoted as t*, is the consensus call for the column. The confidence with which the consensus sequence is called can be determined by establishing a null hypothesis H₀ and then testing H₁, where the underlying template unit is unrestricted, against H₀ for significance. The null hypothesis is agnostic to the underlying template unit for a given column, and thus attributes equal probability to each possibility. The template unit is thereby “fixed,” in a sense. The maximum likelihood of the data under the null model, L₀, is computed as:

$$P ( {d}_{1} , {d}_{2} , {d}_{3} … {d}_{n} \vert {H}_{0} ) = {\sum }_{j = \{ A , C , G , T , - \}} ( \frac{1}{5} ) {\prod }_{k = 1}^{n} P ( {unit}_{observed} = {d}_{k} \vert {unit}_{reference} = j )$$

The maximum likelihood of the data under the alternate hypothesis, L₁, is already computed:

$$P ( {d}_{1} , {d}_{2} , {d}_{3} … {d}_{n} \vert {H}_{1} ) = {\prod }_{k = 1}^{n} P ( {unit}_{observed} = {d}_{k} \vert {unit}_{reference} = {t}^{*} )$$

To assess how much better H₁ is at explaining the data than H₀, compute the likelihood ratio chi square (χ²) statistic:

$${X}^{2} = - 2 log ( \frac{{L}_{0}}{{L}_{1}} )$$

Once the test statistic χ² is obtained for a consensus call, the χ² distribution with degree of freedom=1 can be consulted to infer the probability of observing such a difference or a more extreme one under the null hypothesis model, and the smaller the P-value, the more confident is the consensus call at a given position. A column where observed bases tend to be in agreement is identified as belonging to a post, and the block of contiguous columns (e.g., one or more columns) between two neighboring posts are marked as an island. As noted above, either the Plurality or Decode method can be used to determine a consensus base for a column in a post.

When a significance test is performed, the framework of the null hypothesis can dramatically shape the confidence with which we accept the alternate hypothesis. Hence, in alternative embodiments the null hypothesis described above can be formulated differently while still preserving its purpose of contrasting against the alternative hypothesis. For example, instead of fixing all possibilities {A,C,G,T,-} as equally likely to be the underlying template unit, frequencies can be used that are more consistent given other known factors, e.g., GC % of the genome from which the sequencing template was obtained. Other types of modifications of the methods herein will be understood by the ordinary practitioner based on the teachings herein in light of the current state of the art, and such modifications may be made without departing from the scope and spirit of the invention.

Various MSA approaches that are well known in the art may also be used with the methods herein. In certain embodiments, alignment strategies for use with the methods herein include methods for determining sequence overlap between different sequence reads or between one or more sequence reads and a reference sequence, and preferred embodiments of such alignment strategies are provided, e.g., in U.S. Ser. No. 13/034,233, filed Feb. 24, 2011 and incorporated herein by reference in its entirety for all purposes.

### IV. CONSENSUS SEQUENCE DETERMINATION

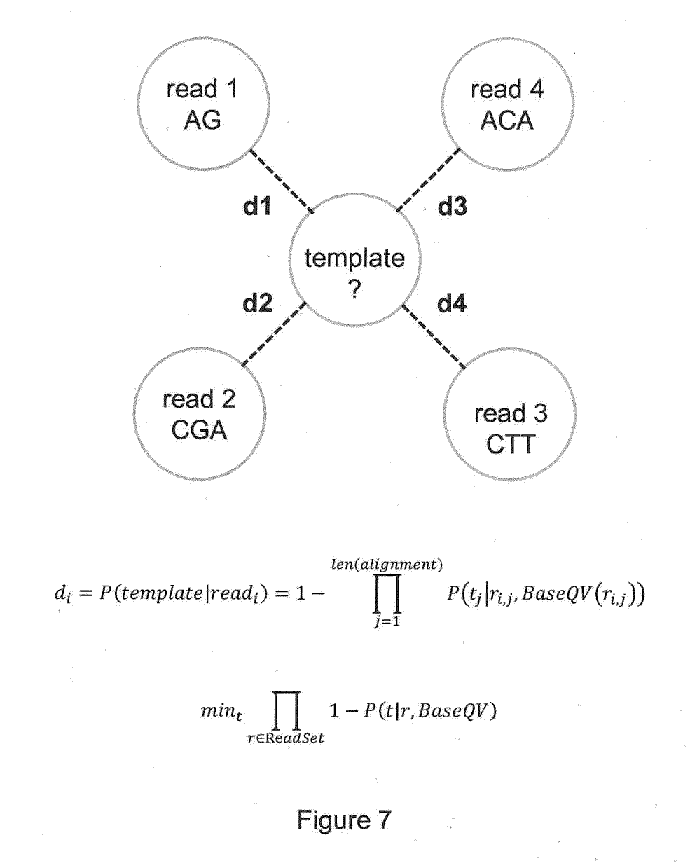

In certain preferred embodiments, once an IA or “island” has been identified as such, e.g., as described above using the Plurality or Decode methods, determination of the best template sequence for the island involves use of the Steiner framework and base quality values (QV's), e.g., at step 6 in FIG. 1. An important aspect of an island is that the reads spanning it are reads independently arising from the same region on the template, that is, the region between two consecutive posts. This aspect of the local consensus problem supports a consensus approximation approach that utilizes the Steiner string framework. Briefly, given such a set of read fragments, the most likely template string is found, which, e.g., minimizes the read-template distance across all reads. The read template distance is computed by 1) aligning the two strings to establish base correspondence, 2) computing the probability of template as the joint probability of individual base transitions, and 3) converting to a distance metric by taking the inverse of the template probability. See FIG. 7 for an exemplary diagram of this approach.

The definition provided in Algorithms on Strings, Trees and Sequences (Gusfield, Dan. Algorithms on Strings, Trees and Sequences. Cambridge University Press, 1997. Cambridge Books Online Cambridge University Press. 9 Jun. 2011; incorporated herein by reference in its entirety for all purposes) for the Steiner string is as follows: “Given a set of strings S, an optimal Steiner string S* for S is a string that minimizes the consensus error E(S*) over all possible strings.” The consensus error E(S*) for S* and another string is measured as the edit distance between the two strings. Therefore, the Steiner string is the sequence that has the smallest edit distance sum when compared to all strings in the set. Computing the Steiner string for a set of reads (or in our case, a set of read fragments (portions of a single, longer sequencing read) determined to come from the same reference region) involves exploring a large set of possibilities and selecting the possibility which yields the minimal edit distance. This can be an expensive process as the length of the read fragments increases. Therefore, use of the Steiner string method on islands within an MSA requires a robust way to quickly find the Steiner sequence without enumerating through all possible sequences up to a designated length. Genetic algorithm, a technique inspired by Darwin's selection process, is a suitable search heuristic for this problem, because the problem meets the two requirements for using genetic algorithms. First, the solution can be expressed in the form of an array in order to apply mutation and/or cross-over operations; and second, the worth of a candidate in the population can be computed with an objective function.

Genetic algorithms use iterative rounds of selection and inheritance to improve the fitness of candidates in the population over time, and traditionally these rounds of selection are exhaustively enumerated, comprising initial populations containing several hundreds or thousands of individuals, each a “possible solution” to the problem. In certain aspects, the present invention provides an algorithm that converges quickly on the correct result without such exhaustive enumeration and large populations of individuals. In this way, the use of genetic algorithms allows much more efficient use of Steiner string to arrive at a consensus sequence for an island. In certain preferred embodiments, the steps for finding optimal solutions to the Steiner string using genetic algorithm are as follows.

Phase I is termed Initialization. A starting population of candidate reads (“individuals”) needs to be generated to serve as seeds. An individual is represented as an array of integers that correspond to bases {A, C, G, T}, or other bases that may occur in the read, e.g., U in an RNA sequence, or methylated or otherwise modified bases that are identifiable by the sequencing system. Essentially, each individual in the population represents a potential solution to the problem being solved, which is to identify a best consensus sequence for a region of the MSA comprising a plurality of reads, e.g., within an island. The population is generated by constructing random N-mers (where N=the mean length of reads in the region of the MSA (e.g., island) being analyzed) until the population size is met. (The sizes of reads in an island may vary where some reads have insertion or deletion errors, for example, which is why a mean is calculated to specify the size of the N-mer candidate reads.) Population size is an important parameter that needs to be selected carefully in order to ensure good initial diversity and adequate representation of the search space. For the problem at hand, the ideal population size will vary depending on the upper limit for read length. It has been shown that a population size of 150 is sufficient for solving read lengths of approximately ten bases, which meets the criteria for islands.

Phase II is termed Selection. During each generation of simulated evolution, individuals in the population are assessed for their “fitness” by measuring the edit distance between each individual and the reads in the set. Based on their fitness measures, a set of individuals is selected to participate in breeding individuals for the next generation via genetic operations. The Steiner sequence (S*) is characterized as having the minimal edit distance sum. Normalization against the number of reads and converting the objective into a maximization problem produces the following equation:

$$Fitness ( x ) {e}^{- ( \frac{{\sum }_{{S}_{i}} ∈ READ \_ {SET}^{EditDist} ( {S}_{i} , X )}{\vert READ \_ SET \vert} )}$$

In order to maintain a healthy diversity in the gene pool and prevent premature convergence to non-optimal solutions, a selection method that preferentially takes high-fitness individuals but still retains some number of “bad” individuals is crucial to being able to generate new solutions in each generation. Roulette-wheel selection is preferably used to achieve this purpose by computing a probability of selection for each individual and spinning the wheel as many times as the pool size. To implement the roulette-wheel selection, the probability that an individual will be selected is computed by comparing its fitness score to its competitors:

$${p}_{i} = \frac{{f}_{i}}{{\sum }_{n = 1}^{\vert population \vert} {f}_{n}}$$

The sum of pᵢ for all individuals should equal one, which is akin to adding up all the slices on a roulette wheel, with those individuals having a higher fitness represented by a larger slice than those having a lower fitness. In order to assign boundaries to the wheel, the cumulative pᵢ is computed for each individual, where cᵢ, ranges between 0 and 1.

$${c}_{i} = {\sum }_{n = 1}^{i} {p}_{n}$$

Next, the “wheel is spun” and the “slice” on which the marker lands is observed. This can be computationally performed by generating a random decimal d between 0 and 1, and the individual i that satisfies cᵢ₋₁≦d<cᵢ is the one selected. After spinning the wheel n times, where n is the size of the population, a parental pool is generated where the frequency of the individuals present in the pool correlates with their fitness. To produce offspring for the next generation, a pair of individuals is randomly selected from the parental pool and breeding continues. Applying crossover procedures to each pair of parents contributes to two offspring, such that selecting n/2 pairs of parents will yield sufficient progeny to fulfill the next generation. (The parents are not returned to the pool for continued breeding.)

Phase III is termed Inheritance. To introduce new individuals to the pool, selected parents contribute partial sequences. Due to the nature of our problem, we want to favor progeny having similar lengths as their parents but with some variability. Therefore, the length of subsequence to extract from each parent is drawn from a Poisson distribution with λ=0.5*parental length. For each set of parents, two progeny individuals will result by considering different orders of the parental contribution. So, each parental sequence is divided into two portions, and then each portion goes to a different progeny. So, parent A has parts A1 and A2 and parent B has B1 and B2, and the two progeny are A1B2 and B1A2.

Phase IV, termed Iteration and Completion, involves sequentially repeating the Selection and Inheritance phases using the new parental pool generated during the prior inheritance phase, which is typically characterized by an increase in best fitness of the population as time progresses. Termination is contingent upon either (a) dropping below a variability threshold within the parental pool or (b) having surpassed a set number of iterations. The second option is the preferred option. For example, for read lengths of approximately 10 bases, at least about 50 iterations can be chosen for converging upon an optimal solution. In certain preferred embodiments, at least about 40-60 iterations are performed. The solution for the Steiner string is represented by the best fitness individual in the final generation, which is taken as the best consensus sequence for the MSA.

In some cases, multiple Steiner strings can be generated for the same initial population of reads. In certain aspects, the present invention provides a method for determining the “best” Steiner string where multiple Steiner strings are generated. For example, in certain preferred embodiments, the most popular transition event for each potential candidate is identified, where a transition event in the context of the present invention is any combination of insertion, deletion, or substitutions. After the most popular transition events are identified, the plausibility of those transition events is assessed using the inherent biases of the system. For example, for each potential template sequence, an “event diagram” is constructed. An event diagram explains template-to-read as well as read-to-read relationships using the simplest set of transitions that is consistent with the observations. The principle of parsimony is applied as a heuristic to eliminate more complex explanations in favor of one that highlights template transitions shared across multiple reads. The more times a transition can apply itself in the change from template to read, the higher the certainty that it actually occurs.

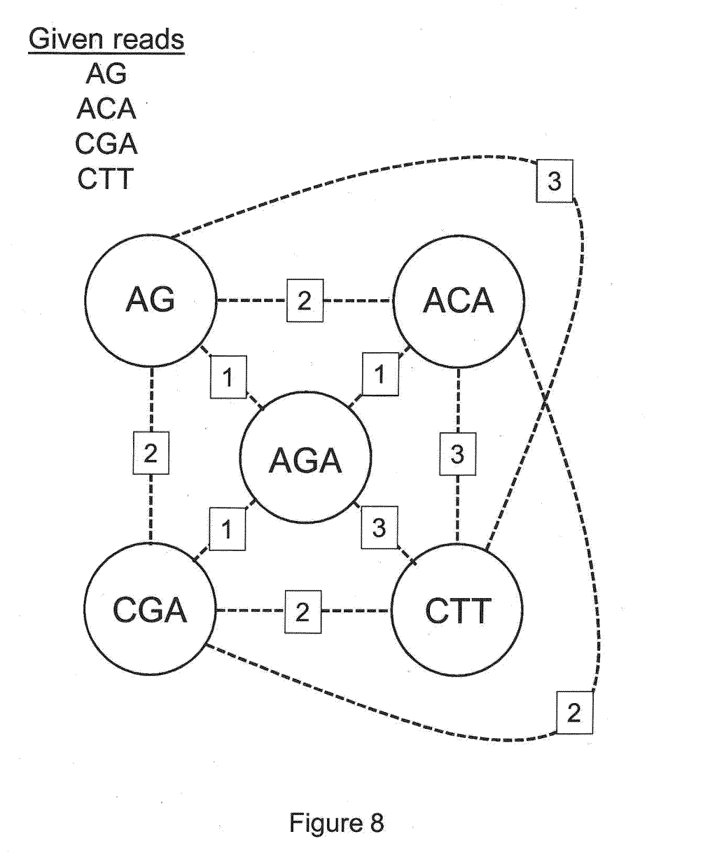

To construct the event diagram, the data can be framed as an undirected and weighted graph. The minimum spanning tree (MST) for the graph is then identified. Reads and template are represented as nodes on the graph, and an edge is drawn for each pair of notes. For example, FIG. 8 provides a graph representation of template AGA and a given set of reads. The nodes are represented in circles, the edges are represented in dotted lines, and the edge weights are represented in squares. The edge cost is computed by the two flanking nodes’ edit distance, defined as the minimum number of insertion, deletion, and substitution operations required to convert one sequence to another. The MST for a connected weighted graph is the tree that connects all nodes in the graph without cycles and uses the least edge weight sum. In this case, the template node is the root of the tree, and all edges orient away from the root. There is a unique path when moving from template to a given read. Prim's algorithm, among others, is a widely-used approach for finding the MST for a graph. The performance of Prim's algorithm varies depending on the data structure that is used to hold the unexplored nodes. When a binary heap is used in the implementation, the computation cost becomes O (|E|log|V|) where |E|=number of edges and |V|=number of vertices in the graph.

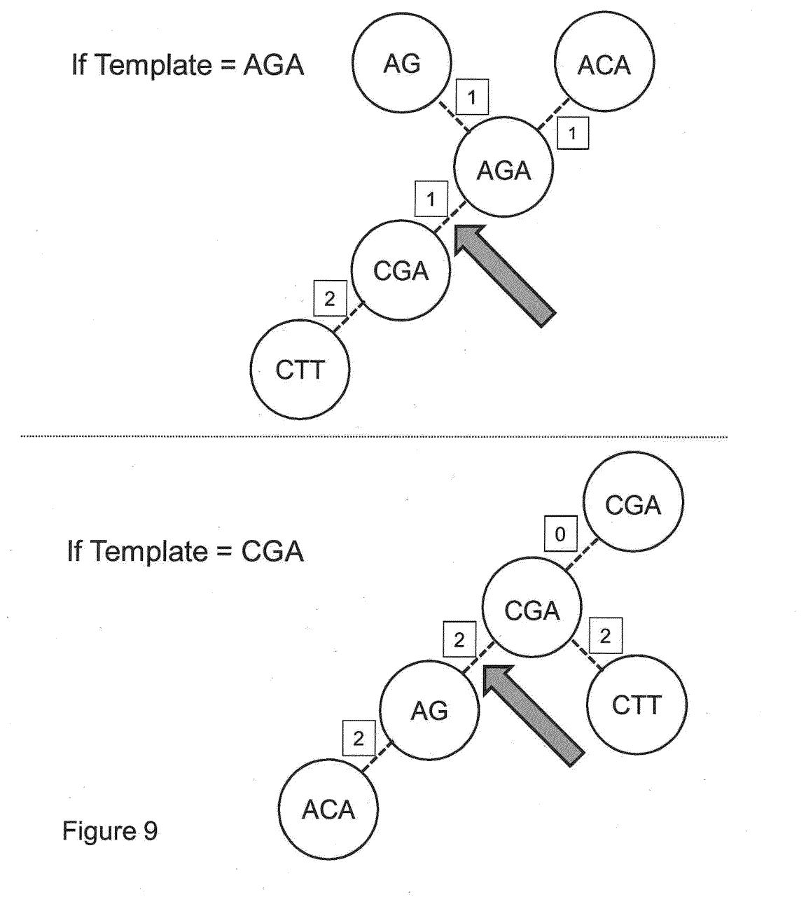

When evaluating different explanations for how a template could give rise to observed reads, pick the tree whose highest degree edge is the most prevalent event given what we know about the sequencing system. The highest degree edge is the edge that participates in the greatest number of template-to-read paths. For example, FIG. 9 provides a comparison of minimum spanning trees for two different templates fitted to the set of reads in FIG. 8. The edge in each tree that marks the highest degree edge of the tree is indicated with an arrow. The prevalence of events can be ordered by using the following criteria:
(1) Rank by increasing edge weight
(2) To resolve ties in (1), rank by event, where insertion>deletion>substitution.
   The problem is solved at this point: consensus=template sequence in the selected tree. For example, in FIG. 9, template candidate AGA can be selected as the “winner” since its highest degree edge is regarded as more prevalent than that of CGA.

The Steiner string approaches provided herein can be modified in various ways. For example, the fitness function may be altered to preserve the same idea of framing the edit distance sum into a maximization problem. Transformations other than the exponential transform can be used. The population size and number of iterations can be varied depending on a number of factors, e.g., the read length requirements of the practitioner. In addition, other methods for finding the MST for a graph can be used, e.g., Kruskal's algorithms and others known in the art. Yet further, the ranking criteria used to determine the prevalence of an event can be adjusted, e.g., depending on the types of errors characteristic of sequencing reads from a given sequencing methodology. Other ways in which this approach can be modified without departing from the scope and spirit of the invention will be recognized by the ordinary artisan in light of the teachings herein. In addition, various methods in the art may be used in conjunction with the methods of the present invention, e.g., Keith, et al. (2002) Bioinformatics 18:1494-1499; Gusfield, Dan. Algorithms on Strings, Trees and Sequences. Cambridge University Press, 1997; and Goldberg, David. Genetic Algorithms in Search, Optimization and Machine Learning. Addison-Wesley Longman Publishing Co., Inc., 1989, all of which are incorporated herein by reference in their entireties for all purposes. In certain related aspects of the present invention, base quality values can be used in determining a local consensus sequence for islands. For example, in the Steiner consensus string approach described above, D(r, t) is defined as the edit distance between read and template. In some embodiments, this measure is used when base-calls are the only data being used to determine the consensus sequence. However, in certain embodiments base-call quality data is also available and used to develop a more accurate measure of D(r, t). As described below, base-call quality data (which can include, e.g., error type, error frequency, pulse metrics, etc.) can be used to estimate the probability of a putative template sequence or “string,” and this probability is converted into a distance metric for a template-read pair. This approach sets up the problem using a framework similar to that of the Steiner consensus string approach described above. For example, given a set of read fragments R={r₁, r₂, r₃, . . . }, and a candidate template t the consensus sequence that minimizes consensus error E(t) across all read fragments can be approximated as Σ_{r∈R}D (r, t), where D(r, t) represents the distance between the observed read fragment and the candidate template.

In preferred embodiments, the process begins with an alignment of the observed read fragment with the putative template string in order to establish a coordinate correspondence. For example, global alignment with a simple [+1|0|0 ] scoring for [match|mismatch|gap] can be used. The resulting correspondence suggests whether an observed base-call is a true incorporation event for a particular base, or instead is an insertion event, e.g., due to cognate or noncognate sampling of the polymerase that did not result in an incorporation event. The probability of the consensus sequence for the template given an observed sequence read can be computed as P(t|r)=Πᵢ₌₁^{len(alignment)}P(tᵢ|rᵢ). Similar to Phred (Ewing, et al. (1988) Genome Research 8:175-185; Ewing, et al. (1988) Genome Research 8:186-194, incorporated herein by reference in their entireties for all purposes), the method described herein produces per-base quality scores as a function of Pₑ, the probability that the base is incorrectly called. Therefore, the inverse function can be applied to deduce and assign a Pₑ to each call in the observed read fragment. Using Pₑ, P(tᵢ|rᵢ) can be calculated for each of the five different possibilities that tᵢ can assume: A, C, G, T, or gap. For example, given Pₑ and observed base call rᵢ where rᵢ is not a gap:

P(tᵢ|rᵢ)=1−Pₑ for tᵢ=rᵢ 1)

P(tᵢ|rᵢ)=Pₑ*10/11 for tᵢ≠rᵢ and tᵢ=gap 2)

P(tᵢ|rᵢ)=Pₑ*1/11*1/3 for tᵢ≠rᵢ and tᵢ≈gap 3)

In cases 2 and 3, the expected ratio of insertion:substitution 10:1, can be used to distribute the total error across cases where the template does not match the observation. The above formulas will work where the aligned unit in the read fragment is a base-call with an associate quality value to identify matches, mismatches, and insertions in the pair-wise alignment. However, in the case of a deletion in the read with respect to the template sequence, a gap is produced which will have no quality values, being a product of the alignment procedure rather than a base-call. In such cases, where rᵢ is a gap, an expected deletion probability, e.g., based on the known characteristics of a given sequencing platform, can be used to estimate P (tᵢ|rᵢ). Once P(tᵢ|rᵢ) is computed, the distance can be computed as (r, t)=1−P(t|r). As such, the distance D decreases as the likelihood of the template string increases.

At step 7 in FIG. 1, the consensus sequences for each island are optionally catenated with the majority calls for the posts to generate a best consensus sequence for the biomolecule. The probabilities generated for each best consensus sequence at each island can be used to compute a global probability estimate for the final consensus target sequence. Another beneficial result of this decomposition of the target sequence is the generation of a family of consensus sequences for each island that includes the global probability estimates for each consensus sequence in the family. Such a representation might be useful for preserving information about ambiguities for downstream steps. For example, a family of consensus sequences could be determined and later disambiguated by comparison to additional sequencing data.

### V. COMPUTER IMPLEMENTATION

In certain aspects, the methods provided herein are computer-implemented methods, wherein at least one or more steps of the method are carried out by a computer program. In some embodiments, the methods provided herein are implemented in a computer program stored on computer-readable media, such as the hard drive of a standard computer. For example, a computer program for determining at least one consensus sequence from replicate sequence reads can include one or more of the following: code for providing or receiving the replicate sequence reads, code for grouping replicate sequence reads, code for analyzing call quality, code for aligning the replicate sequence reads to generate an MSA, code for refining an MSA, code for identifying islands and posts in the MSA or refined MSA, code for generating consensus sequences for the posts, code for generating consensus sequences for the islands, code for catenating consensus sequences with sequences in posts, and a computer-readable storage medium comprising the codes.

In some embodiments, a system (e.g., a data processing system) that determines at least one consensus sequence from a set of replicate sequences includes a processor, a computer-readable medium operatively coupled to the processor for storing memory, wherein the memory has instructions for execution by the processor, the instructions including one or more of the following: instructions for receiving input of replicate sequence reads, instructions for grouping replicate sequence reads, instructions for analyzing call quality, instructions that align the replicate sequence reads, instructions that refine an alignment, instructions that identify islands and posts, instructions that generate consensus sequence for at least one post, instructions that generate consensus sequence for at least one island, instructions that catenate consensus sequence from an island with sequence from one or two adjacent posts, instructions that compute/store information related to various steps of the method (e.g., quality scores, error rates, etc.), and instructions that record the results of the method.

In certain embodiments, various steps of the method utilize information and/or programs and generate results that are stored on computer-readable media (e.g., hard drive, auxiliary memory, external memory, server, database, portable memory device (CD-R, DVD, ZIP disk, flash memory cards, etc.), and the like. For example, information used for and results generated by the methods that can be stored on computer-readable media include but are not limited to replicate sequence information, MSAs, refined MSAs, post loci and/or sequences, island loci and/or sequences, newly generated consensus sequences, newly generated catenated sequences, quality information, technology information, and homologous or reference sequence information.

In some aspects, the invention includes an article of manufacture for determining at least one consensus sequence from replicate sequence reads that includes a machine-readable medium containing one or more programs which when executed implement the steps of the invention as described herein.

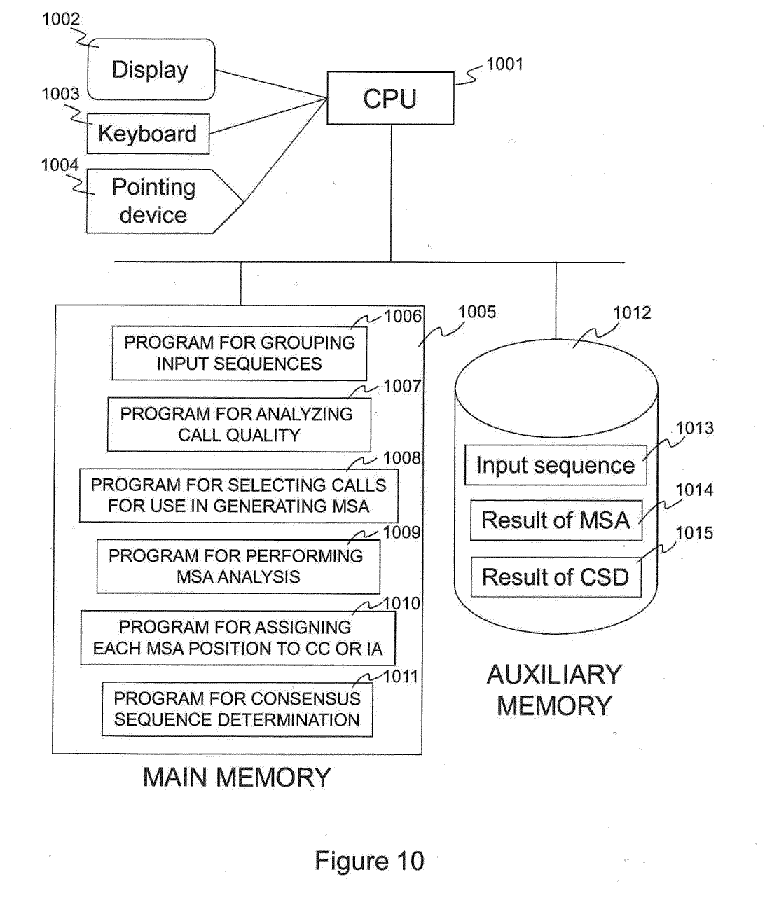

FIG. 10 is a block diagram showing a representative example of a configuration of a device for consensus sequence determination in which various aspects of the invention may be embodied. As will be understood to practitioners in the art from the teachings provided herein, the invention can be implemented in hardware and/or software. In some embodiments of the invention, different aspects of the invention can be implemented in either client-side logic or server-side logic. As will be understood in the art, the invention or components thereof may be embodied in a fixed media program component containing logic instructions and/or data that when loaded into an appropriately configured computing device cause that device to perform according to the invention. As will be understood in the art, a fixed media containing logic instructions may be delivered to a viewer on a fixed media for physically loading into a viewer's computer or a fixed media containing logic instructions may reside on a remote server that a viewer accesses through a communication medium in order to download a program component.

FIG. 10 shows an information appliance (or digital device) 1000 that may be understood as a logical apparatus that can read information (e.g., instructions and/or data) from auxiliary memory 1012, which may reside within the device or may be connected to the device via, e.g., a network port or external drive. Auxiliary memory 1012 may reside on any type of memory storage device (e.g., a server or media such as a CD or floppy drive), and may optionally comprise multiple auxiliary memory devices, e.g., for separate storage of input sequences, results of MSA, results of CSD, and/or other information. Device 1000 can thereafter use that information to direct server or client logic, as understood in the art, to embody aspects of the invention.

One type of logical apparatus that may embody the invention is a computer system as illustrated in FIG. 10, containing a CPU 1001 for performing calculations, a display 1002 for displaying an interface, a keyboard 1003, and a pointing device 1004, and further comprises a main memory 1005 storing various programs and a storage device 1012 that can store the input sequence 1013 and results of multiple sequence alignment (MSA) 1014 and consensus sequence determination (CSD) 1015. The device is not limited to a personal computer, but can be any information appliance for interacting with a remote data application, and could include such devices as a digitally enabled television, cell phone, personal digital assistant, etc. Information residing in the main memory 1005 and the auxiliary memory 1012 may be used to program such a system and may represent a disk-type optical or magnetic media, magnetic tape, solid state dynamic or static memory, etc. In specific embodiments, the invention may be embodied in whole or in part as software recorded on this fixed media. The various programs stored on the main memory can include a program 1006 to group the input sequences that contain sequence for a given target sequence, a program 1007 to analyze the quality of the calls in the input sequence, a program 1008 to identify calls to be included in the MSA analysis, a program 1009 to carry out the MSA analysis, a program 1010 to assign each position in the MSA to a post or an island, a program 1011 to apply a model to determine consensus sequences for each island, and a program to catenate island consensus sequences with post majority calls to generate a target consensus sequence. The lines connecting CPU 1001, main memory 1005, and auxiliary memory 1012 may represent any type of communication connection.

After input replicate sequences and parameters required for the method of the present invention are specified by the display 1002 (also referred to as a “screen”), the keyboard 1003, and the pointing device 1004, the CPU 1001 executes the program stored in the main memory 1005 and the MSA and consensus sequence determination are performed by the methods of the present invention. The input sequence 1013 is read from the storage device 1012. The output result of MSA 1014 and consensus sequence determination 1015 can be stored into the storage devices 1012. During the progress of MSA and consensus sequence determination by the method of the present invention, the progress of this processing can be displayed on the display 1002. After completing this processing, the result of the processing can be also displayed on the display 1002, saved to an additional storage device (e.g., ZIP disk, CD-R, DVD, floppy disk, flash memory card, etc.), or displayed and/or saved in hard copy (e.g., on paper). The result of the processing may be stored or displayed in whole or in part, as determined by the practitioner. For example, the results for one or more positions, or one or more islands, or one or more combinations of islands and posts may be displayed/saved. These results may further comprise quality information, technology information (e.g., peak characteristics, expected error rates), alternate (e.g., second or third best) consensus sequences, confidence metrics, etc., as described in greater detail above.

It is to be understood that the above description is intended to be illustrative and not restrictive. It readily should be apparent to one skilled in the art that various modifications may be made to the invention disclosed in this application without departing from the scope and spirit of the invention. The scope of the invention should, therefore, be determined not with reference to the above description, but should instead be determined with reference to the appended claims, along with the full scope of equivalents to which such claims are entitled. Throughout the disclosure various references, patents, patent applications, and publications are cited. Unless otherwise indicated, each is hereby incorporated by reference in its entirety for all purposes. All publications mentioned herein are cited for the purpose of describing and disclosing reagents, methodologies and concepts that may be used in connection with the present invention. Nothing herein is to be construed as an admission that these references are prior art in relation to the inventions described herein.

### VII. EXAMPLES

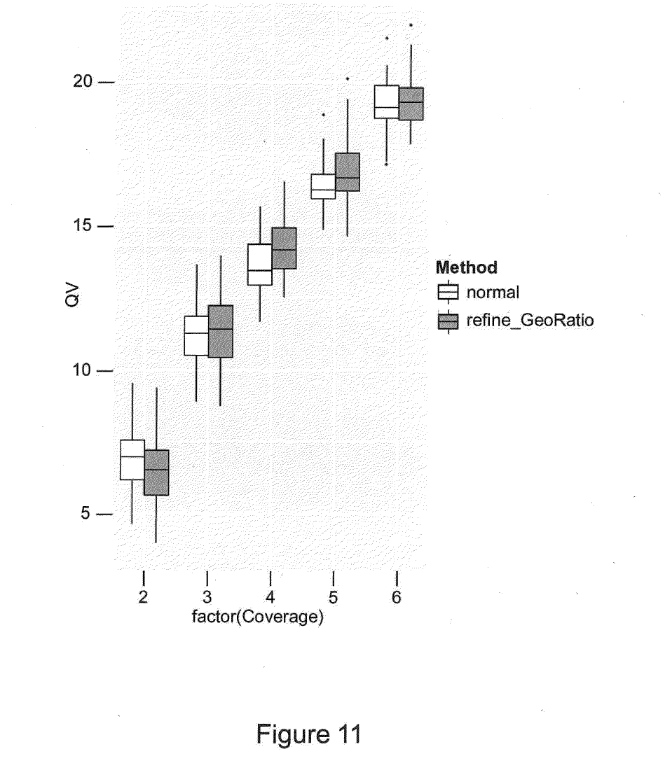

To assess the results of an MSA refinement procedure, consensus calling accuracy at low coverage (2-6×) was compared. A reference sequence was mutated at every 500^{th} position to contain a different base at each mutated position, and the resulting mutated reference represented the resequencing “reference” sequence. The original (unmutated) reference sequence represented the “sample” sequence. These two sequences were used for consensus sequence determination using the simulated annealing MSA refinement procedure described at length elsewhere herein. The results shown in FIG. 11 were generated after performing fifty independent trials, where reference mutation and read set depreciation were done independently for each trial. These results support the conclusion that this MSA refinement strategy improves low consensus calling. Term η, which varies directly with Δ(coverage)/Δ(Consensus QV), is also improved for the workflow with MSA refinement. (Term η is a term representing how quickly technology/algorithmic methods can augment consensus accuracy with additional read redundancy.)

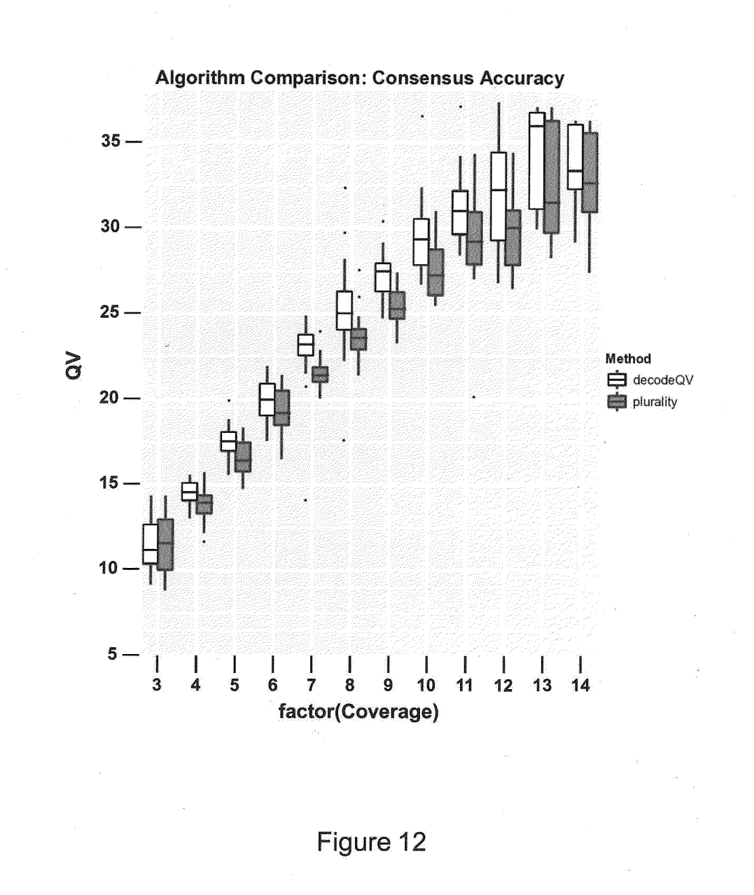

To assess the results of the quality value-derived distance metric for the Steiner consensus framework, the methodology was applied on C. elegans fosmid data, subsampled at 12× coverage. The reference sequence used for mapping was mutated such that, on average, 1 in 500 positions would carry a base substitution. The resulting consensus calls were then evaluated against the un-mutated reference for consensus calling accuracy in the low coverage regime and benchmarked against plurality consensus calling. FIG. 12 provides the resulting comparison of consensus calling accuracy using the quality value-based algorithm provided herein versus a plurality-based strategy. From these results, it is clear that the c20, or minimum coverage necessary to achieve a consensus accuracy of 20, is 6 for the methodology described herein for this particular sequence data, which compares well with the plurality consensus calling.

What is claimed is:

1. A method of refining a multiple sequence alignment, comprising:
a) providing an initial multiple sequence alignment;
b) perturbing a portion of the initial multiple sequence alignment to generate a candidate multiple sequence alignment having a perturbed portion;
c) evaluating the candidate multiple sequence alignment by scoring the portion of the initial multiple sequence alignment to generate a first score, and scoring the perturbed portion of the candidate multiple sequence alignment to generate a second score; and
d) accepting the candidate multiple sequence alignment as a new multiple sequence alignment if the second score is greater than the first score.

2. The method of claim 1, wherein the initial multiple sequence alignment comprises a biomolecular sequence.

3. The method of claim 2, wherein the biomolecular sequence is a polynucleotide sequence.

4. The method of claim 2, further comprising performing at least one sequencing-by-incorporation assay to provide the biomolecular sequence.

5. The method of claim 1, wherein the providing comprises aligning a plurality of replicate sequence reads using one or more MSA algorithms.

6. The method of claim 1 iteratively applied, wherein the new multiple sequence alignment is subsequently perturbed and evaluated.

7. The method of claim 1, wherein the method is a computer-implemented method.

8. The method of claim 1, wherein the perturbing comprises performing a gap shifting operation on at least one column of the initial multiple sequence alignment.

9. The method of claim 8, wherein the scoring comprises computation of a geometric mean of a signal-to-noise ratio within the column.

10. The method of claim 1, wherein the scoring comprises application of an objective function:
$$S = \sqrt[\vert block \vert]{{\prod }_{i = 1}^{i = \vert block \vert} \frac{Count ( most\_frequent \_base \_in {\_col}_{i} )}{Count ( 2 nd\_frequent \_base \_in {\_col}_{i} )}} .$$

11. A method for determining a consensus call, comprising:
a) generating a set of training sequence reads from a known template sequence using a given sequencing system;
b) using the set of training sequence reads and a given alignment schema to generate a training multiple sequence alignment, where a read is a series of units, and wherein a unit is either a base call or a single base gap;
c) measuring unit association occurrences in the training multiple sequence alignment;
d) determining conditional probabilities for each combination of training sequence units and a known template sequence unit;
e) generating a set of experimental sequence reads from an unknown template sequence using the given sequencing system;
f) using the set of experimental sequence reads and the given alignment schema to generate an experimental multiple sequence alignment;
g) for each column in the experimental multiple sequence alignment having a plurality of units therein, using the conditional probabilities to compute the likelihoods of observing the plurality of units for each of a set of possible template units for the column; and
h) identifying which of the possible template units gives the highest likelihood in step g and identifying it as the consensus call for the column.

12. The method of claim 11, further comprising using a χ² statistic to determine confidence in the consensus call for the column.

13. A method for generating a consensus sequence for a region of a multiple sequence alignment, the method comprising:
a) providing a multiple sequence alignment comprising a set of actual reads across a region of interest;
b) providing a set of randomly generated candidate reads for the region of interest having a length equal to a mean length of the actual reads;
c) measuring an edit distance between each of the randomly generated candidate reads and the set of actual reads to generate a fitness for each of the randomly generated candidate reads;
d) selecting a subset of the randomly generated candidate reads, wherein the selecting preferentially chooses randomly generated candidate reads having high fitness with respect to others in the set of randomly generated candidate reads;
e) pairing members of the subset selected in step d to produce a plurality of pairs of candidate reads;
f) subjecting each of the pairs of candidate reads to a crossover procedure to generate a first set of recombined candidate reads;
g) subjecting the set of recombined candidate reads to the measuring of step c, the selecting of step d, the pairing of step e, and the subjecting of step f to generate a further set of recombined reads;
h) sequentially repeating step g, each time using the set of recombined candidate reads from an immediately prior crossover procedure of step f for a subsequent measure of step c;
i) terminating the sequentially repeating, thereby providing a final set of recombined candidate reads;
j) measuring an edit distance between each member of the final set of recombined candidate reads and the set of actual reads to generate a fitness for each member of the final set of recombined candidate reads; and
k) determining which member of the final set of recombined candidate reads has a best fitness as a fittest candidate read, and identifying the fittest candidate read as the consensus sequence for the region of the multiple sequence alignment.

14. The method of claim 13, wherein fitness is computed using an equation:
$$Fitness ( x ) = {e}^{- ( \frac{{\sum }_{{S}_{i}} ∈ READ \_ {SET}^{EditDist} ( {S}_{i} , X )}{\vert READ \_ SET \vert} )} .$$

15. The method of claim 13, wherein the selecting of step d retains some of the randomly generated candidate reads having low fitness with respect to others in the set of randomly generated candidate reads.

16. The method of claim 13, wherein the selecting of step d is performed using a roulette-wheel selection.

17. The method of claim 13, wherein multiple fittest candidate reads are identified in step k, the method further comprising:
l) constructing an undirected and weighted graph comprising nodes representing a first of the multiple fittest candidate read and portions of the actual reads that overlap the first within the multiple sequence alignment;
m) repeating step l for all of the fittest candidate reads;
n) generating a minimum spanning tree for each of the undirected and weighted graphs constructed in steps l and m, thereby generating a set of minimum spanning trees;
o) determining which of the minimum spanning trees has a highest degree edge, wherein the highest degree edge is an edge that participates in the greatest number of template-to-read paths; and
p) identifying which of the multiple fittest candidate reads is represented within the minimum spanning tree having the highest degree edge, wherein this multiple fittest candidate read is chosen as the consensus sequence for the region of the multiple sequence alignment.

18. The method of claim 17, wherein each of the fittest candidate reads is a root of one of the set of minimum spanning trees.

19. The method of claim 13, wherein the edit distance is computed using both base calls from the actual reads and a base quality value for each of the base calls.

20. A system for generating a consensus sequence, comprising:
a) computer memory containing an alignment of a set of replicate sequence reads;
b) computer-readable code for determining an optimal Steiner string for the alignment, wherein the optimal Steiner string is the consensus sequence; and
c) memory for storing the consensus sequence generated in step b.
